(19) United States
(12) Patent Application Publication
(10) Pub. No.: US 2012/0179594 A1
(43) Pub. Date: Jul. 12, 2012

(54) CREDIT ALLOCATION IN AN OPEN ORDER MANAGER

(75) Inventors: Lee COLE, Evergreen, CO (US); Douglas G. KITTELSEN, Evergreen, CO (US); M. Gary LAFEVER, Lyons, CO (US); Ted MYERSON, Boynton Beach, CO (US)

(73) Assignee: FTEN, INC., New York, NY (US)

(21) Appl. No.: 13/311,182

(22) Filed: Dec. 5, 2011

Related U.S. Application Data
(60) Provisional application No. 61/507,902, filed on Jul. 25, 2011.
(60) Provisional application No. 61/419,874, filed on Dec. 5, 2010.

(51) Int. Cl. G06Q 40/04

(52) U.S. Cl. 705/37

(57) ABSTRACT

The technology described in this application allows a system to manage entities/users and associated Financial Articles of Trade (“FAT”) with different trading systems, institutions and entities. In particular, an Open Order Manager (“OOM”) manages a plurality of users in a user group, and preferably in real-time, monitors FAT transactions initiated and executed by the users. The OOM enables allocation and dynamic reallocation of the FAT amounts between and among “nodes” (e.g., a financial system or financial institution) which can include any subcomponent arrangement that has internal permission privileges which are not shared among other nodes but all of which are under control or ownership of a common party in interest.

### CROSS-REFERENCES TO RELATED APPLICATIONS

This application claims the benefit of priority from provisional application No. 61/507,902 filed Jul. 25, 2011 and from provisional application No. 61/419,874 filed on Dec. 5, 2010, the contents of which are incorporated herein by reference.

### BACKGROUND

Many financial transaction trading systems allow users to initiate transactions. For example, financial transaction trading systems allow traders to place orders for purchasing a particular stock and the orders are matched and eventually processed. In past financial transaction trading systems, trades could be initiated and completed over the course of several minutes. Now, most financial transaction trading systems can initiate and complete transactions within microseconds.

Traders today also use multiple, unrelated financial transaction trading systems to initiate trades across several different exchange matching platforms. For example, a trader can initiate a trade across the NASDAQ Stock Exchange while at the same time initiate another trade across the New York Stock Exchange.

With the increase in speed and the diversity of trading systems and exchange matching platforms, millions of transactions are initiated and completed over the course of a single day. There is thus a widespread reliance on unrelated transaction trading systems, exchange matching platforms and financial institutions in which to complete these transactions.

In executing these transactions, multiple factors are taken into account before a transaction can be completed. Continuing with the trading example, when executing a trade, a particular trader may have an established credit amount from a particular financial institution. If the trader is only interacting with one financial institution, then the financial institution can determine how to adjust the credit for the trader, should the trader request to exceed the current credit amount. Established credit amounts, monitoring credit, and adjusting credit are universal concerns of any entity involved in financial transactions. Credit is an example of a broader category of a decision making authority supervising permission privileges.

A problem exists when an entity initiates one or more financial transactions using multiple, unrelated transaction trading systems, exchange matching platforms and/or financial institutions. These trading systems, exchange matching systems and institutions may not communicate with each other, and in some instances, may require that certain information between the system/platform/institution and the entity remain confidential so that the other competing or nonintegrated system/platform/institutions have no knowledge of the details of the relationship between the entity and the initial system/platform/institution.

Currently, present systems do not allow for an entity to allocate particular transaction limits between the entity and the system/platform/institution across multiple, unrelated or nonintegrated transaction systems, exchange matching platforms, and financial institutions. There is thus a need for a transaction management system that can manage asset allocation for multiple users/entities interacting with multiple, unrelated or nonintegrated transaction systems, exchange matching platforms, and financial institutions.

### SUMMARY

The technology described in this application attempts to solve these problems by allowing a system to manage the entities/users and associated Financial Articles of Trade (“FAT”) with different institutions and entities. In particular, an Open Order Manager (“OOM”) manages a plurality of users in a user group, and in real-time, monitors FAT transactions initiated and executed by the users. The OOM enables allocation and dynamic reallocation of the FAT amounts between and among unrelated or nonintegrated institutions and entities despite the lack of common permission privileges a user and/or user group may have with each entity.

Upon monitoring these transactions, the OOM can, for example, establish FAT allocation limits between a user (e.g., a trader) and a transaction trading system, an exchange matching platform (e.g., NASDAQ stock exchange or New York Stock Exchange) or a financial institution (e.g., a bank). The OOM can also monitor asset sub-limits between a user and a transaction system, exchange matching platform or a financial institution. This system advantageously allows management of financial transactions for a group of users across multiple, unrelated systems.

An open order management apparatus comprises a memory configured to store one or more financial transaction groupings and one or more processors, coupled to the memory, configured to execute open order management in the open order management apparatus. The one or more processors create a financial transaction grouping having one or more nodes, establish a total limit for the financial transaction grouping, establish individual limits for each node in the financial transaction grouping, determine an available credit amount for the financial transaction grouping corresponding to a difference between the total limit and a sum of the individual limits for each node, monitor transactions conducted by each node, and adjust an individual limit for a node in the financial transaction grouping when the node requires the adjusted individual limit.

Another aspect relates to an open order management system, comprising a transaction node apparatus having a memory configured to store transactions conducted by a transaction node, and one or more processors, coupled to the memory, and configured to conduct transactions for the transaction node. The open order management system also includes an open order management apparatus having a memory configured to store one or more financial transaction groupings, and one or more processors, coupled to the memory, configured to execute open order management in the open order management apparatus. The one or more processors in the open order management apparatus create a financial transaction grouping having one or more nodes, establish a total limit for the financial transaction grouping, establish individual limits for each node in the financial transaction grouping, determine an available credit amount for the financial transaction grouping corresponding to a difference between the total limit and a sum of the individual limits for each node, monitor transactions conducted by each node, and adjust an individual limit for a node in the financial transaction grouping when the node requires the adjusted individual limit.

Another aspect relates to a method for open order management used in an open order management apparatus, the open order management apparatus having one or more processors, and the method comprising creating a financial transaction grouping having one or more nodes, establishing a specific limit for the financial transaction grouping, establishing individual limits for each node in the financial transaction grouping, determining an available credit amount for the financial transaction grouping corresponding to a difference between the total limit and a sum of the individual limits for each node, monitoring transactions conducted by each node, and adjusting an individual limit for a node in the financial transaction grouping when the node requires the adjusted individual limit.

A non-transitory computer-readable storage medium having computer readable code embodied therein and capable of being stored in a memory as computer program instructions, which when executed by a computer having one or more processors, performs the method for open order management described in the preceding paragraph.

In a non-limiting, example implementation individual limits for each node are determined based on the total limit divided by a combination of a total number of nodes in the financial transaction grouping plus a predetermined integer constant.

In another non-limiting, example implementation increasing the predetermined integer constant increases the available credit amount for the financial transaction grouping.

In yet another non-limiting, example implementation individual credit sub-limits are established for each node in the financial transaction grouping where the credit sub-limits correspond to limits between each node and one or more financial institutions.

In another non-limiting, example implementation the method further comprises determining a current limit for the node requiring the adjusted individual limit (when the node has conducted enough transactions causing the node to exceed the current individual limit), determining a currently available credit amount for the financial transaction grouping, and determining if the currently available credit amount can be allocated to the node requiring the adjusted limit.

In yet another non-limiting, example implementation if the currently available credit amount can be allocated to the node requiring the adjusted individual limit, the method further comprises reducing the currently available credit amount for the financial transaction grouping based on current transaction requirements of the node, and increasing the individual limit for the node based on the current transaction requirements of the node.

In another non-limiting, example implementation if the currently available credit amount cannot be allocated to the node requiring the adjusted individual limit, the method further comprises determining a candidate node for individual limit adjustment, increasing the individual limit for the node requiring the adjusted individual limit based on current transaction requirements of the node, and reducing the individual limit for the candidate node to correspond to the increased individual limit for the node requiring the adjusted individual limit.

### BRIEF DESCRIPTION OF THE DRAWINGS

FIG. 1 is a block diagram of an example embodiment of the present technology;

FIG. 2 is a block diagram of another example embodiment of the present technology;

FIG. 3a is an application flowchart showing an implementation of the present technology;

FIG. 3b is an application flowchart showing details of a process depicted in FIG. 3a;

FIGS. 4a-4e show examples of an OOM's FAT allocation process;

FIG. 5 shows an example embodiment of an OOM in the present system;

FIG. 6 shows an example screenshot of an application screen of the present technology; and

FIG. 7 shows an example screenshot of another application screen of the present technology.

### DETAILED DESCRIPTION OF THE DRAWINGS

In the following description, for purposes of explanation and non-limitation, specific details are set forth, such as particular nodes, functional entities, techniques, protocols, standards, etc. in order to provide an understanding of the described technology. It will be apparent to one skilled in the art that other embodiments may be practiced apart from the specific details described below. In other instances, detailed descriptions of well-known methods, devices, techniques, etc. are omitted so as not to obscure the description with unnecessary detail. Individual function blocks are shown in the figures. Those skilled in the art will appreciate that the functions of those blocks may be implemented using individual hardware circuits, using software programs and data in conjunction with a suitably programmed microprocessor or general purpose computer, using applications specific integrated circuitry (ASIC), and/or using one or more digital signal processors (DSPs). The software program instructions and data may be stored on computer-readable storage medium and when the instructions are executed by a computer or other suitable processor control, the computer or processor performs the functions. Although databases may be depicted as tables below, other formats (including relational databases, object-based models and/or distributed databases) may be used to store and manipulate data.

Although process steps, algorithms or the like may be described or claimed in a particular sequential order, such processes may be configured to work in different orders. In other words, any sequence or order of steps that may be explicitly described or claimed does not necessarily indicate a requirement that the steps be performed in that order. The steps of processes described herein may be performed in any order possible. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention(s), and does not imply that the illustrated process is preferred. A description of a process is a description of an apparatus for performing the process. The apparatus that performs the process may include, e.g., a processor and those input devices and output devices that are appropriate to perform the process.

Various forms of computer readable media may be involved in carrying data (e.g., sequences of instructions) to a processor. For example, data may be (i) delivered from RAM to a processor; (ii) carried over any type of transmission medium (e.g., wire, wireless, optical, etc.); (iii) formatted and/or transmitted according to numerous formats, standards or protocols, such as Ethernet (or IEEE 802.3), SAP, ATP, Bluetooth, and TCP/IP, TDMA, CDMA, 3G, etc.; and/or (iv) encrypted to ensure privacy or prevent fraud in any of a variety of ways well known in the art.

The present system relates to “Financial Articles of Trade” defined for purposes hereof as each representing a financial interest/asset or the right to acquire a financial interest/asset where the Financial Article of Trade is fungible in nature (i.e., equally recognizable and accepted at a variety of places and/or by a variety of parties) and delivered (or communicated/represented) electronically such that there is no (or very minimal) cost or degradation in value from transfer from on physical or logical location to another. Examples of Financial Articles of Trade include, but are not limited to, rights related to cash, credit, equity securities, debt securities, commodities, futures, options, swaps, foreign exchange values, balances, rates, etc. For simplicity sake, the Financial Articles of Trade will be generally referred to below as FAT.

The need for this system is created by the practice of parties with rights to a number of a financial interests/assets to allocate such financial interests/assets among a variety of nodes—each of which nodes may have internal controls or checks but which nodes do not share common permission privileges with other nodes therefore leading to inefficient use of the financial interests/assets. Although not limited to this example, a node can be a device, such as a computer system, or can be an entity associated with a device, such as a person and/or business.

As explained above, the present system provides an OOM that collects information regarding a party's permission privileges. These permission privileges can be, for example, privileges related to credit or any privileges that a decision making authority may create or supervise. That information is allocated among a number of nodes that themselves do not share common permission privileges. The OOM enables allocation and dynamic reallocation of FATs between and among disparate nodes despite the lack of common permission privileges.

The non-limiting examples described below depict the use of an OOM in a transaction management system that monitors FAT limits for various transaction partners operating across different transaction firms. As described below, the transaction partners have a finite number of FATs in which to conduct transactions and the OOM helps manage the allocation of FATs between the transaction partners and the various institutions the transaction partners interact with. It should be appreciated that the OOM can be implemented as a single node (e.g., in a server computer) or can be implemented across multiple nodes (e.g., in a peer-to-peer network).

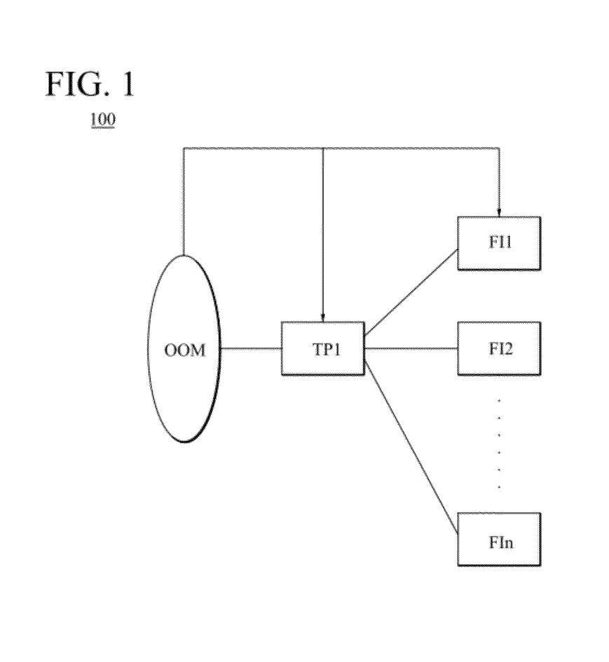

FIG. 1 shows an example embodiment of an OOM being used for a single user in a user group (e.g., transaction partner TP1) in a transaction management system 100 where the transaction partner TP1 interacts with several financial institutions FI1-FIn. In this example, the transaction partner TP1 has an overall order limit that she can place on orders based on the FAT values allocated from each financial institution FI1-FIn. So for example, the total amount the transaction partner TP1 may use, as a whole, may be $100,000.

In this example, the $100,000 amount is allocated amongst the different financial institutions FI1-FIn. So, if there are five financial institutions FI1-FI5, the $100,000 could be allocated equally amongst each institution, having $20,000 available for use at each institution. Although not limited to this embodiment, the financial institutions FI1-FIn could be a bank or a credit card company.

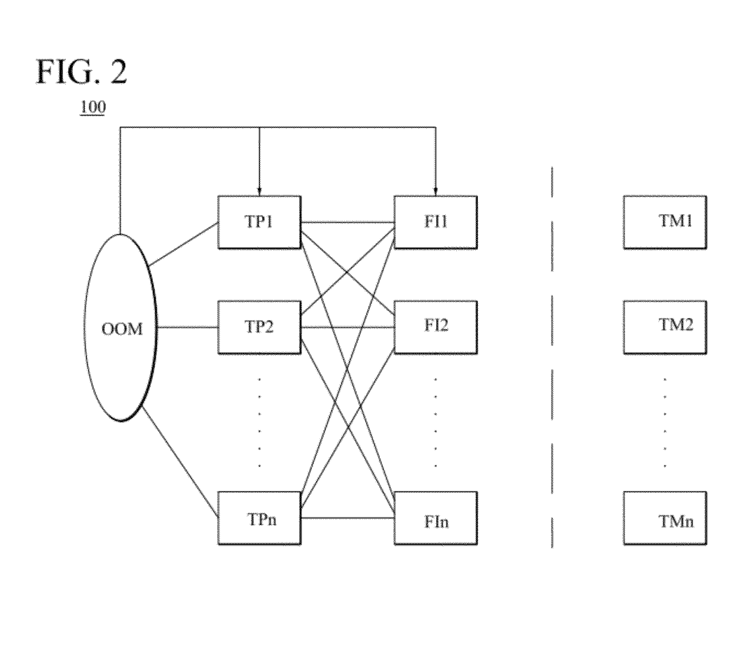

FIG. 2 depicts another example embodiment of an OOM being used in a transaction management system 100. In particular, FIG. 2 shows a setup between an OOM and one or more users in a user group where the users interact with a particular system. The user group could be a financial transaction grouping and the users can be one or more nodes in the financial transaction grouping. Examples of financial transaction groupings include the total amount of FATs allocated to a single entity but distributed among disparate trading systems which are not integrated with one another (each disparate and non-integrated trading system would constitute a node) or the total amount of FATs allocated to a single entity but distributed among individual traders working on behalf of the entity (each different individual trader would constitute a node).

In the example shown in FIG. 2, the OOM interacts with multiple transaction partners TP1-TPn where each transaction partner TP1-TPn interacts with a particular financial institution FI1-FIn. Through the limits set by each financial institution, the multiple transaction partners TP1-TPn can interact with various transaction mediums TM1-TMn. The limits that are set by each financial institution are not limited to currency, such as U.S. dollars, but can also include a credit limit or the total shares of stock in a particular company. The limits can also includes total shares of stock in a particular company stock available for stock loans as collateral against “short” position trades taken against such stock.

In the example shown in FIG. 2, transaction partner TP1 has the ability to initiate transactions across multiple transaction mediums TM1-TMn. In this example, the OOM can set the overall FAT limit that the transaction partner TP1 can use in placing orders across TM1-TMn. The OOM can then determine the sub-limit allocation between the transaction partner TP1 and each financial institution FI1-FIn.

For example, the transaction partner TP1 may only be entitled to use $50,000 worth of FATs from financial institutions FI1-FIn. The OOM can monitor and/or manage the allocation of these FATs for transaction partner TP1 between financial institutions FI1-FIn. So for example, if there are five financial institutions FI1-FI5, the OOM can allocate $10,000 for each of the financial institutions FI1-FI5 that transaction partner TP1 can use for executing transactions across the various transaction mediums TM1-TMn.

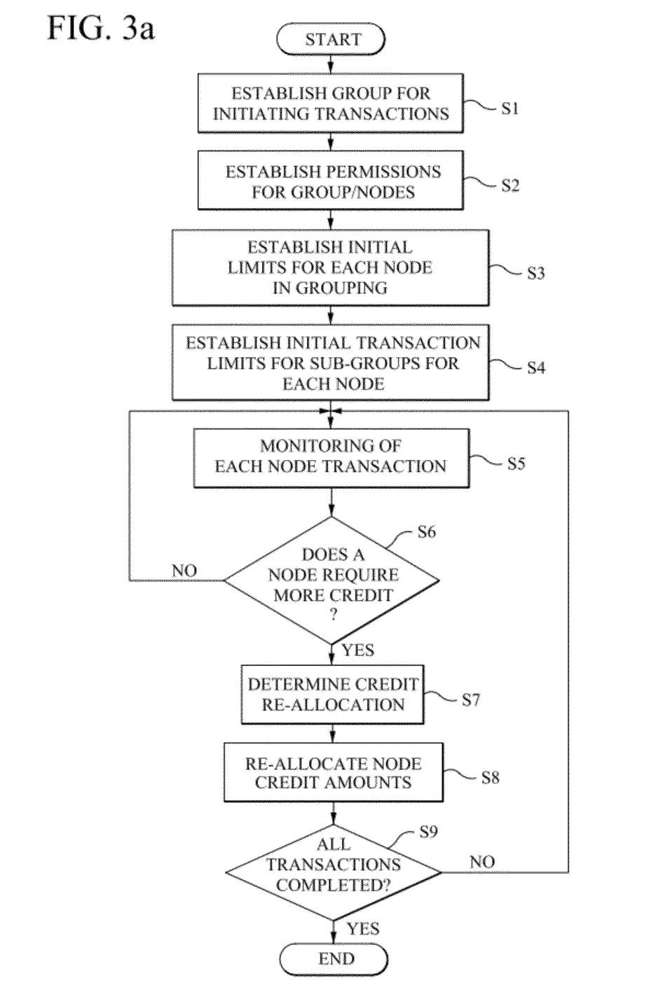

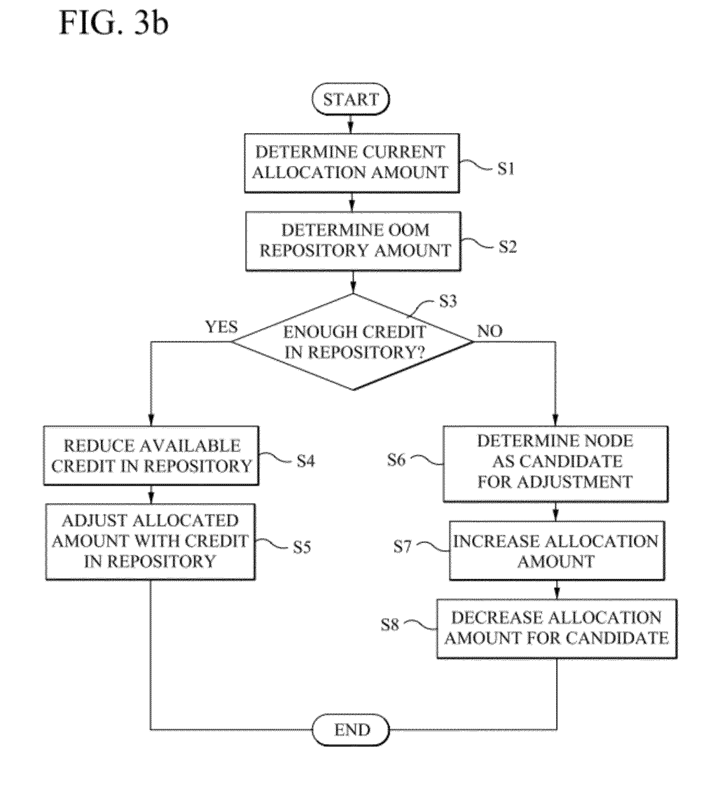

FIG. 3 shows an application flowchart of an example implementation of the transaction management system 100. The system begins in step S1 where the group for initiating transactions is established. In an example embodiment, a user, such as a system administrator, will create a group on the OOM for initiating transactions. The group can be, for example, the multiple transaction partners TP1-TPn.

Once the group is created, the system proceeds to step S2 where the permissions for the group and/or each individual group member are set. The permissions can relate to any facet of the group or group member's ability to operate within the boundaries of the system. For example, the group and/or individual group member may have certain restrictions related to a particular financial institution or transaction medium that they can interact with.

After establishing the group and its particular permissions, the system proceeds to step S3 where initial transaction limits are set for each member in the group. In setting the initial transaction limits, the value can be generated automatically or can be custom configured to each individual user. In an example embodiment, the system will establish an overall FAT limit for all of its users and then allocate the FATs equally amongst the users while leaving some FATs available in an FAT repository.

For example, a group may have three users and a total FAT allocation value of $100,000. In dividing the available amount amongst the users, the system will divide an equal portion to each user, and then keep a portion of the available FATs in an FAT repository. So for example, the total amount can be divided amongst the total number of users plus some integer constant. For the sake of example, we can assume the constant integer to be 2. So the system will divide the $100,000 in 5 units (3 users plus the constant 2) for $20,000 in each unit. Therefore, the three users in the group each receive $20,000 to spend in available FATs, while the remaining $40,000 are placed into the FAT repository.

After the system sets the initial transaction limits for each group member, the system proceeds to step S4 where it can set the sub-limits for each group member. Using the example from FIG. 2, each transaction partner TP1 can use a particular financial institution FI1-FIn for placing its particular orders with each particular transaction medium TM1-TMn. The system can use any method for determining the FAT sub-limits for each group member.

In a preferred embodiment, the system will set the various FAT sub-limits using the algorithm defined above so that each individual user has their own FAT repository to pull from as needed. So for example, if each user in the group has $20,000 as an overall FAT limit and there are three financial institutions each user can interact with, the system will distribute $4,000 to each financial institution and will leave $8,000 available in a repository for the individual group member. For purposes of explanation, the system in the examples described below will only have an overall FAT repository for the group so each group member's $20,000 will be allocated equally between each of the financial institutions FI1-FIn.

Once the FAT limits and FAT sub-limits are established, the system will proceed to step S5 where it will monitor, preferably in real-time, the various user's transactions. By monitoring these transactions, the system can determine if a particular user is about to exceed their FAT limit.

As the system monitors each user's transaction in real-time, the system proceeds to step S6 where it determines if a particular group member is about to exceed a FAT limit.

If the system determines that a group member has exceeded or would exceed a FAT limit, the system proceeds to S7 where the system determines FAT limit reallocation. The details of determining the reallocation of the FAT limit are discussed with respect to FIG. 3b.

After determining the group member's FAT limit reallocation, the system then proceeds to step S8 where it re-adjusts the particular group member's FAT limit. So for example, a transaction partner TP1 may attempt to execute a transaction that would exceed the $4,000 FAT limit for financial institution FI1. As described below, the system may then adjust the FAT limit for financial institution FI1 so that the group member will be able to execute the transaction.

FIG. 3b shows an application flowchart for describing the FAT limit reallocation process discussed in the description of FIG. 3a. In step S1, the system determines the group member's current FAT limit value. Using the example from above, the FAT limit value for transaction partner TP1 using financial institution FI1 is $4,000.

After determining the group member's particular FAT value, the system proceeds to step S2 where it determines the amount available in the FAT repository. Although not limited to this embodiment, the FAT repository can be the overall FAT repository determined for the group by the OOM or can be the group member's individual FAT repository.

After determining the available repository amount, the system proceeds to step S3 where it determines if enough credit is available in the repository to complete the transaction. If enough credit is available, the system proceeds to step S4 where the system determines how to reduce credit in the repository.

In step S4, the credit can be taken from the FAT repository in a variety of ways. In one example, enough credit can be extracted from the repository to cover the cost of the current proposed transaction. In a preferred embodiment, the system will have a configured percentage that it will take from the FAT repository. So for example, if the repository has $40,000 of available FATs and the configured percentage is set to 20%, the group member will receive 20% of the FATs from the repository. As such, the repository's total credit will be reduced by $8,000 (i.e. 20% of $40,000) to $32,000.

It should be appreciated that various criteria may be established for each group member for receiving credit from the repository. For example, the percentage each group member may take from the repository may be individually configured so that one user may take, for example, 20% from the repository, where another group member may take only 10% from the repository. Additionally, the repository may have a minimum amount that it requires to be available for other group members so as to prevent a particular group member from depleting all of the available credit from the repository.

Once the system reduces the repository's credit in step S4, the system proceeds to step S5 where it adjusts the group member's FAT limit by the amount the group member received from the FAT repository. So in this example, transaction partner TP1 will now have received $8,000 that can be distributed across a single financial institution FI1 or divided amongst one or more financial institutions FI1-FIn.

If the system determines that there is not enough credit available in the FAT repository for the group member to use, the system will move to step S6 where the system will look to other group members to determine if the FAT limits can be adjusted. So for example, if a transaction partner TP1 has attempted to exceed her $20,000 limit, and there is no more credit available from the FAT repository, the system will look to the other transaction partners TP2-TPn to determine if their FAT limit values can be adjusted. So if a transaction partner TP2 is only using $10,000 of her overall $20,000 FAT limit, the system may adjust transaction partner TP2's FAT limit in order to increase transaction partner TP1's FAT limit.

Once the system selects a “candidate” for FAT limit re-adjustment, the system proceeds to step S7 and step S8 where it adjusts the particular group member's FAT limits. So in this example, transaction partner TP1 will have her FAT limit increased by $10,000 (the amount not currently being used by transaction partner TP2) and transaction partner TP2 will have her FAT limit decreased by $10,000.

It should be appreciated that there are many ways in which the readjustment value for a particular group member can be determined. For example, only a fraction of the group member's unused available FATs may be allocated to the group member in need of the FATs, or several group members FAT limits may be reduced to increase the FAT limit for one group member. Of importance is the ability to dynamically adjust a group member's FAT limit by decreasing the FAT limits of members that may not be using as many FAT resources. Further examples of the limit reallocation process are discussed below.

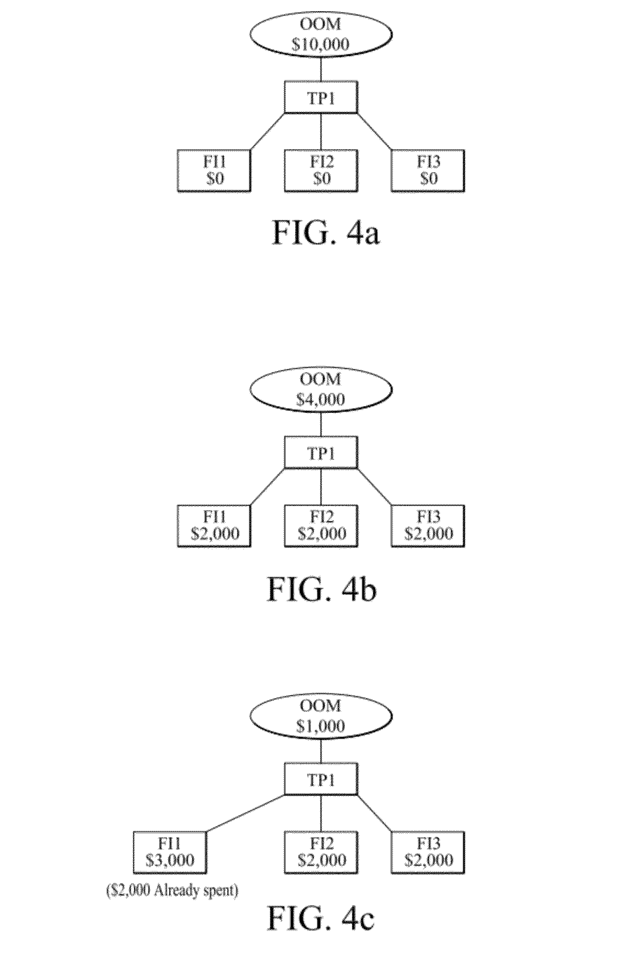

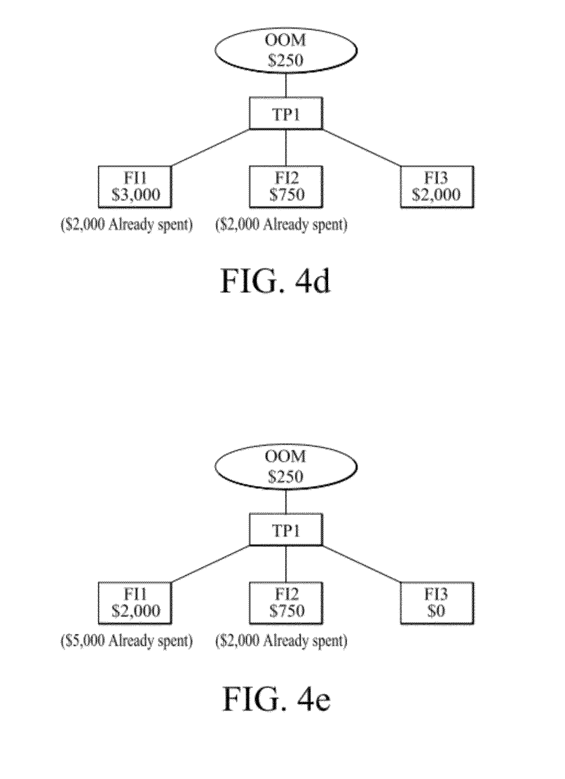

FIGS. 4a-4e depict examples of an OOM's FAT allocation process between a single transaction partner TP1 and three financial institutions FI1-FI3. In this example, each financial institution allows the transaction partner TP1 to use an allotted amount of FATs for conducting transactions. The financial institutions FI1-FI3 can establish limits for the transaction partner TP1 from using more than the allotted amount for the transactions and can adjust the limits, as needed should the transaction partner TP1 require more or less FATs.

Each financial institution has the ability to monitor, preferably in real-time, the FATs used by the transaction partner TP1 for the specific financial institution. However, the financial institutions FI1-FI3 do not share “permission privileges” between them so as to enable sharing of information among them. That is, the amount of FATs allocated to the transaction partner TP1 are effectively hidden between the financial institutions FI1-FI3. As such, the OOM is used to collectively measure the amount of FATs allocated, as a whole, to the transaction partner TP1.

As explained above, the present system enables the transaction partner TP1, who has permission privileges with regard to each institution, to ensure that the total FATs used by all of the institutions do not exceed a specified amount. In one example, this can be accomplished by tracking the total amount that the transaction partner TP1 desires to be used and allocating a portion of that amount amongst all of the institutions while reserving a portion of that amount in a FAT repository in the OOM for potential future reallocation among the financial institutions.

FIG. 4a shows an example of a transaction partner TP1 interacting with three financial institutions FI1-FI3 where that total amount allocated for use by the transaction partner TP1 is $10,000. Initially, each financial institution FI1-FI3 will initially be set to $0 for allocation amongst the institutions. The system will then determine how to allocate the total amount between each financial institution FI1-FI3.

In an example embodiment, the system can take the total amount (i.e. $10,000) and divide it by the total number of financial institutions (i.e., 3) plus some predetermined number “n.” In this example, n can be 2 so the $10,000 will be divided by 5 (3 financial institutions plus the predetermined value 2) allotting 5 units of $2,000 each.

As shown in FIG. 4b, the units will be allocated between each financial institution FI1-FI3 so each institution has $2,000 with $4,000 as the remainder sitting in the OOM FAT repository. Now, for example, say transaction partner TP1 uses all of the $2,000 FATs allocated to institution FI1. The “node” FI1 could then communicate with the OOM to request additional FATs for allocation. The OOM, for example, could be programmed to release a portion of available FATs upon request from a node representing a financial institution so as to retain some reserved FATs for additional potential reallocation.

FIG. 4c shows an example where a specified percentage is taken from the FAT repository for reallocation. In this example, 75% of available FATs are released, keeping 25% available for future reallocation. Assuming the $2,000 is already used from financial institution FI1, the institution will request additional FAT allocation from the OOM and will receive $3,000 for use ($4,000×75%=$3,000) leaving a balance of $1,000 worth of FATs in the OOM for additional reallocation. Financial institution FI1 will now have $3,000 worth of FATs to use, having already spent $2,000 worth of FATs.

FIG. 4d shows an example where financial institution FI2 has used the $2,000 allocated to it and is now requesting additional funds from the FAT repository in the OOM. Once again, the OOM will release the fixed percentage selected and will give $750 to financial institution FI2, leaving $250 as a balance in the OOM repository. Financial institution FI2 will now have an allocated amount of $750 having already used its initial $2,000 allocated for it initially. In this example, financial institution FI2 does not have any particular requirements for how many FATs it needs, so the $750 satisfies the amount of FATs currently needed for financial institution FI2.

FIG. 4e shows an example where financial institution FI1 has once again used all of its total FATs, spending $5,000 currently allocated to it. In this example, financial institution FI1 requires an additional $2,000 and makes another request to the OOM for additional FATs. The OOM, not having enough FATs in the FAT repository, will now look to available FATs from the other financial institutions, FI2 and FI3. The OOM can be programmed, for example, to recall allocated FATs previously granted to financial institutions, either based on some allocation among institutions or based on a lack of activity at one or more institutions.

In the example shown in FIG. 4e, financial institution FI3 has yet to use any of its initially allocated FATs. The OOM may therefore adjust the allocated FATs at FI3 so that FI1 can receive additional FATs. In FIG. 4e, financial institution FI1 receives the $2,000 worth of FATs allocated initially to institution FI3 so that FI3 now has $0 worth of FATs available for use. Of course, the FAT allocation is not limited to this example and could take portions from other institutions as well (i.e. financial institution FI2).

It should be appreciated that the above examples shown in FIGS. 4a-4e are a simplified representation of an embodiment of the present system. For purposes of this system, a “node” (e.g., a financial system or financial institution) can include any subcomponent arrangement that has internal permission privileges which are not shared among other nodes but all of which are under control or ownership of a common party in interest.

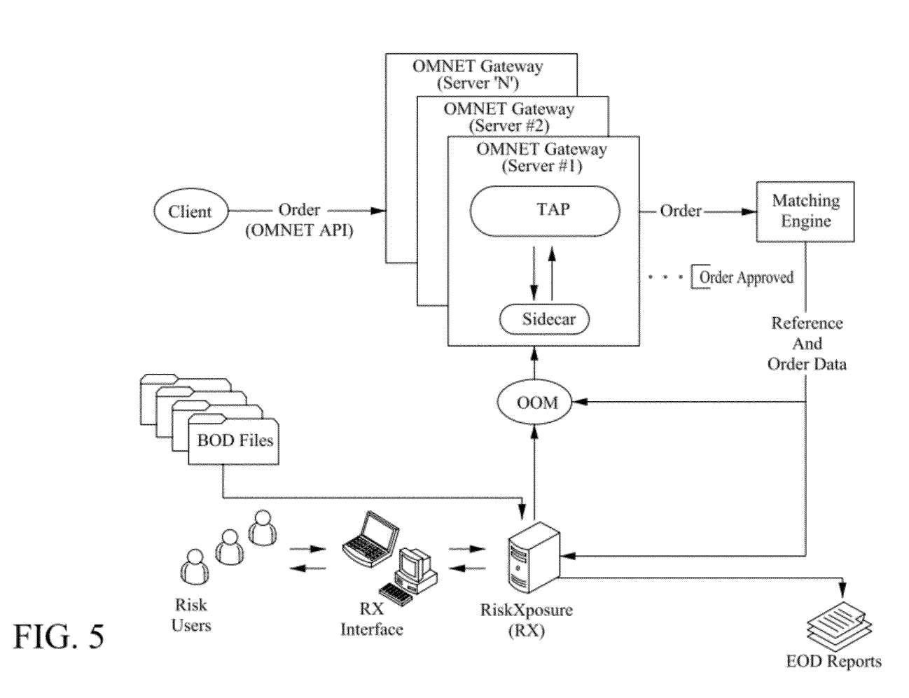

In another example embodiment, the system could be implemented in a risk management system for a securities trading exchange, as shown in FIG. 5. The system can allocate risk threshold limits among distributed nodes, and each of the nodes would not have common permission privileges but all of the nodes would be under common ownership or control of a party in interest.

FIG. 5 shows, for example, a risk exposure system (“RX”) interacting with the OOM. The risk exposure system RX is a centralized risk management engine that provides real-time financial securities risk management and control capabilities that enable integration with market participants' back office financial securities systems in order to support a centralized risk configuration.

Included in FIG. 5 are Beginning of Day Processes files (“BOD”) which are files reflecting the results of trading activity from the previous day that are run before the start of trading to be ready for the trading day. Along with the BOD files are particular risk groups (“RG”) that are a collection of accounts that are grouped together to create a portfolio that can be managed in the RX risk exchange system. All accounts in a risk group share contract limits and credit allocation.

Also included in FIG. 5 is a Sidecar (“SC”) which is an exemplary embodiment of a software node interacting with an OOM gateway to accomplish dynamic reallocation of available credit for transaction purposes as generally outlined above.

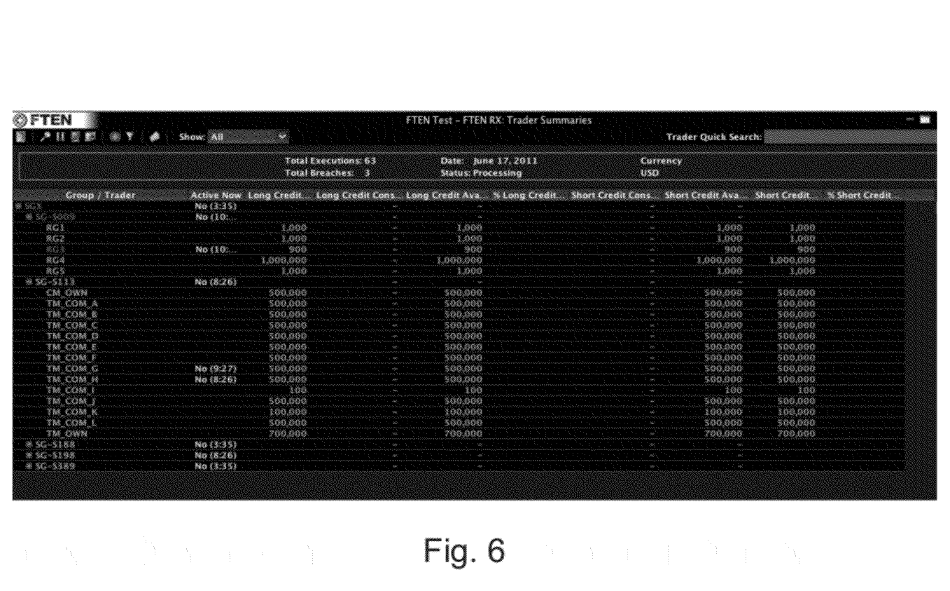

FIG. 6 depicts an example screenshot of an application screen in the present system. FIG. 6 shows, for example, a hierarchy used for groups/traders in the risk exchange system RX that interacts with the OOM. In an example embodiment, the hierarchy is generated during the initial startup of the OOM application.

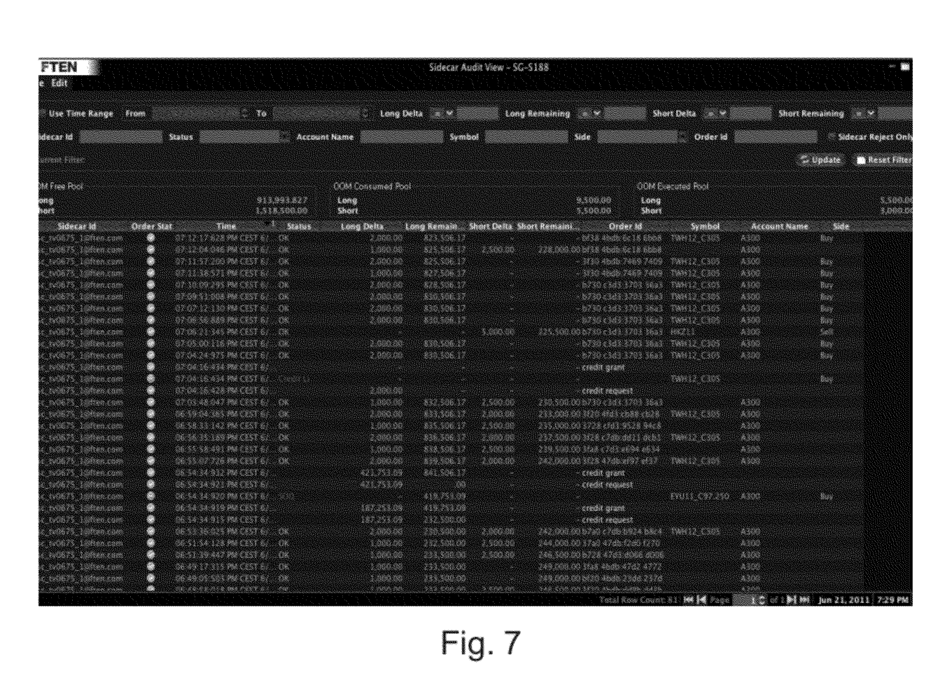

FIG. 7 depicts another example screenshot of another application screen in the present system. FIG. 7 shows, for example, a sidecar SC audit view showing per-order decisions made by the Sidecar SC. The audit view helps a user accomplish dynamic reallocation of available credit for transaction purposes.

While the technology has been described in connection with example embodiments, it is to be understood that the claims are not limited to the disclosed embodiments, but on the contrary, are intended to cover various modifications and equivalent arrangements.

1. A method for open order management used in an open order management apparatus, the open order management apparatus having one or more processors, the method comprising:
creating a financial transaction grouping having one or more nodes;
establishing a specific credit limit for the financial transaction grouping;
establishing individual credit limits for each node in the financial transaction grouping;
determining, via the one or more processors, an available credit amount for the financial transaction grouping corresponding to a difference between the specific credit limit and a sum of the individual credit limits for each node;
monitoring, via the one or more processors, transactions conducted by each node; and
adjusting, via the one or more processors, an individual credit limit for a node in the financial transaction grouping when the node requires the adjusted individual credit limit.

2. The method for open order management according to claim 1, further comprising determining individual credit limits for each node based on the specific credit limit divided by a combination of a total number of nodes in the financial transaction grouping plus a predetermined integer constant.

3. The method for open order management according to claim 2, wherein increasing the predetermined integer constant increases the available credit amount for the financial transaction grouping.

4. The method for open order management according to claim 2, further comprising establishing individual credit sub-limits for each node in the financial transaction grouping, the credit sub-limits corresponding to limits between each node and one or more financial institutions.

5. The method for open order management according to claim 1, further comprising:
determining a current credit limit for the node requiring the adjusted individual credit limit, the node requiring the adjusted individual credit limit when the node has conducted enough transactions causing the node to exceed the current individual credit limit;
determining a currently available credit amount for the financial transaction grouping; and
determining if the currently available credit amount can be allocated to the node requiring the adjusted credit limit.

6. The method for open order management according to claim 5, wherein if the currently available credit amount can be allocated to the node requiring the adjusted individual credit limit, the method further comprising:
reducing the currently available credit amount for the financial transaction grouping based on current transaction requirements of the node; and
increasing the individual credit limit for the node based on the current transaction requirements of the node.

7. The method for open order management according to claim 5, wherein if the currently available credit amount cannot be allocated to the node requiring the adjusted individual credit limit, the method further comprising:
determining a candidate node for individual credit limit adjustment;
increasing the individual credit limit for the node requiring the adjusted individual credit limit based on current transaction requirements of the node; and
reducing the individual credit limit for the candidate node to correspond to the increased individual credit limit for the node requiring the adjusted individual credit limit.

8. A non-transitory computer-readable storage medium having computer readable code embodied therein and capable of being stored in a memory as computer program instructions, which when executed by a computer having one or more processors, performs the method for open order management of claim 1.

9. An open order management apparatus, comprising:
a memory configured to store one or more financial transaction groupings; and
one or more processors, coupled to the memory, configured to execute open order management in the open order management apparatus and configured to:
create a financial transaction grouping having one or more nodes;
establish a specific credit limit for the financial transaction grouping;
establish individual credit limits for each node in the financial transaction grouping;
determine an available credit amount for the financial transaction grouping corresponding to a difference between the specific credit limit and a sum of the individual credit limits for each node;
monitor transactions conducted by each node; and
adjust an individual credit limit for a node in the financial transaction grouping when the node requires the adjusted individual credit limit.

10. The open order management apparatus of claim 9, wherein individual credit limits are determined for each node based on the specific credit limit divided by a combination of a total number of nodes in the financial transaction grouping plus a predetermined integer constant.

11. The open order management apparatus of claim 10, wherein the one or more processors are further configured to establish individual credit sub-limits for each node in the financial transaction grouping, the credit sub-limits corresponding to limits between each node and one or more financial institutions.

12. The open order management apparatus of claim 9, wherein the one or more processors are further configured to:
determine a current credit limit for the node requiring the adjusted individual credit limit, the node requiring the adjusted individual credit limit when the node has conducted enough transactions causing the node to exceed the current individual credit limit;
determine a currently available credit amount for the financial transaction grouping; and
determine if the currently available credit amount can be allocated to the node requiring the adjusted credit limit.

13. The open order management apparatus of claim 12, wherein if the currently available credit amount can be allocated to the node requiring the adjusted individual credit limit, the one or more processors are further configured to:
reduce the currently available credit amount for the financial transaction grouping based on current transaction requirements of the node; and
increase the individual credit limit for the node based on the current transaction requirements of the node.

14. The open order management apparatus of claim 13, wherein if the currently available credit amount cannot be allocated to the node requiring the adjusted individual credit limit, the one or more processors are further configured to:
determine a candidate node for individual credit limit adjustment;
increase the individual credit limit for the node requiring the adjusted individual credit limit based on current transaction requirements of the node; and
reduce the individual credit limit for the candidate node to correspond to the increased individual credit limit for the node requiring the adjusted individual credit limit.

15. An open order management system, comprising:
a transaction node apparatus having:
a memory configured to store transactions conducted by a transaction node; and
one or more processors, coupled to the memory, and configured to conduct transactions for the transaction node, and
an open order management apparatus having:
a memory configured to store one or more financial transaction groupings; and
one or more processors, coupled to the memory, configured to execute open order management in the open order management apparatus and configured to:
create a financial transaction grouping having one or more nodes;
establish a specific credit limit for the financial transaction grouping;
establish individual credit limits for each node in the financial transaction grouping;
determine an available credit amount for the financial transaction grouping corresponding to a difference between the specific credit limit and a sum of the individual credit limits for each node;
monitor transactions conducted by each node; and
adjust an individual credit limit for a node in the financial transaction grouping when the node requires the adjusted individual credit limit.

16. The open order management system of claim 15, wherein individual credit limits are determined for each node based on the specific credit limit divided by a combination of a total number of nodes in the financial transaction grouping plus a predetermined integer constant.

17. The open order management system of claim 16, wherein the one or more processors in the open order management apparatus are further configured to establish individual credit sub-limits for each node in the financial transaction grouping, the credit sub-limits corresponding to limits between each node and one or more financial institutions.

18. The open order management system of claim 15, wherein the one or more processors in the open order management apparatus are further configured to:
determine a current credit limit for the node requiring the adjusted individual credit limit, the node requiring the adjusted individual credit limit when the node has conducted enough transactions causing the node to exceed the current individual credit limit;
determine a currently available credit amount for the financial transaction grouping; and
determine if the currently available credit amount can be allocated to the node requiring the adjusted credit limit.

19. The open order management system of claim 18, wherein if the currently available credit amount can be allocated to the node requiring the adjusted individual credit limit, the one or more processors in the open order management apparatus are further configured to:
reduce the currently available credit amount for the financial transaction grouping based on current transaction requirements of the node; and
increase the individual credit limit for the node based on the current transaction requirements of the node.

20. The open order management system of claim 18, wherein if the currently available credit amount cannot be allocated to the node requiring the adjusted individual credit limit, the one or more processors in the open order management apparatus are further configured to:
determine a candidate node for individual credit limit adjustment;
increase the individual credit limit for the node requiring the adjusted individual credit limit based on current transaction requirements of the node; and
reduce the individual credit limit for the candidate node to correspond to the increased individual credit limit for the node requiring the adjusted individual credit limit.
